(19) United States
(12) Patent Application Publication
(10) Pub. No.: US 2005/0246576 A1
(43) Pub. Date: Nov. 3, 2005

(54) Redundant system utilizing remote disk mirroring technique, and initialization method for remote disk mirroring for in the system

(76) Inventor: Masaaki Takayama, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/080,815

(22) Filed: Mar. 16, 2005

(30) Foreign Application Priority Data
Mar. 30, 2004 (JP) 2004-100984

(51) Int. Cl. G06F 11/00

(52) U.S. Cl. 714/6

(57) ABSTRACT

During initialization for remote disk mirroring in a redundant system, the copy driver of a running computer copies only the data of valid blocks to a disk of a standby computer in accordance with block management information used for management by the file system of the running computer. After the initialization, the remote-disk-mirroring driver of the running computer duplicates a request for writing data to a disk of the running computer, thereby causing the running computer to write the data to the disk of the running computer, and causing the standby computer to write the data to the disk of the standby computer.

### CROSS-REFERENCE TO RELATED APPLICATIONS

This application is based upon and claims the benefit of priority from prior Japanese Patent Application No. 2004-100984, filed Mar. 30, 2004, the entire contents of which are incorporated herein by reference.

### BACKGROUND OF THE INVENTION

1. Field of the Invention

The present invention relates to a redundant system for duplicating data by writing data to both a running computer and a standby computer connected to the running computer via a network. More particularly, the invention relates to a redundant system utilizing a remote disk mirroring technique for mirroring the contents of a disk in a standby computer to a disk in a running computer, and also to an initialization method for remote disk mirroring for use in the redundant system.

2. Description of the Related Art

A redundant system (distributed system) called a cluster system is known from, for example, Tetsuo Kaneko and Ryoya Mori, “Cluster Software”, Toshiba Review, Vol. 54, No. 12 (1999), pp. 18-21. This redundant system utilizes a fail-over technique. The redundant system (cluster system) is characterized in that when a failure occurs in a running computer, the services having been executed in the computer are relayed to another computer (standby computer) that is in, for example, a hot-standby state (i.e., a fail-over technique).

The redundant system utilizing the fail-over technique utilizes a remote disk mirroring (RDM) technique. The RDM technique is characterized in that write data is duplicated between different computers (nodes) connected to each other via a network, thereby enhancing the integrity of data. In general, in the RDM technique, setting of computers (nodes) as mirroring targets and disks (disk drives) is performed before the computers start to operate as a redundant system. Further, between the computers as the mirroring targets, it is determined which one of the computers should serve as a running computer or standby computer. When the system is running, the running and standby computers communicate with each other via the network. As a result of this communication, the data written to a disk (mirroring target disk) in the running computer is also written to a disk (mirroring target disk) in the standby computer, thereby duplicating data on the disk of each computer.

In the remote disk mirroring technique, initialization for remote disk mirroring is needed. Initialization of remote disk mirroring means the process of making the contents of the mirroring target disk of the standby computer coincide with those of the mirroring target disk of the running computer. In the initialization of the system, all data on the disk of the running computer is copied to the disk of the standby computer by communication via the network. Accordingly, it costs many hours to execute initialization for remote disk mirroring in the redundant system utilizing the fail-over technique.

Jpn. Pat. Appln. KOKAI Publication No. 2003-6015 (hereinafter referred to “the patent document”) discloses a redundant system called a distributed mirrored disk system. This system is characterized in that when data is written to a disk of a computer in the system, it is copied to a disk of another computer in the system. As a result of data copy, the data recorded in a disk of each computer is duplicated. This redundant system divides the area of each disk of each computer into blocks and manages the blocks. Each computer holds flags corresponding to the respective blocks. If corresponding blocks in the computers may store different data, the flags corresponding to the blocks are set. When one of the computers of the system writes data to a block of a disk of the one computer, it sets, before writing data, a flag corresponding to the block, and causes the other computer to set a flag of the other computer corresponding to the block. Upon confirming that the corresponding flag in the other computer is set, the one computer writes data to the disk, and causes the other computer to copy the data to a disk thereof. After confirming that data copy is completed, the one computer clears its flag, and causes the other computer to clear the corresponding flag.

In the above-described redundant system (distributed mirrored disk system), assume that one of the computers has once failed and then recovers from the failure. In this case, restoration processing for making the contents of the disks of the computers coincide with each other is necessary. This restoration processing is executed simply by mutually copying the block indicated by the set flag (this indicates inconsistency) in the computer that holds the latest data, and the block indicated by the set flag (this indicates inconsistency) in the other computer recovered from the failure. Thus, in the redundant system disclosed in the patent document, data on a disk of each computer can be duplicated by simple copy processing. However, when a failure occurs in a disk of a certain computer in the system and the disk is replaced, copy processing between disks similar to initialization for remote disk mirroring must be performed.

As described above, the conventional remote disk mirroring technique for a redundant system utilizing a fail-over technique requires, at the start of operating the system, initialization (for remote disk mirroring) for making the contents of mirroring target disks coincide with each other. This initialization costs many hours since it is executed by copying all data of the mirroring target disk of a running computer to the mirroring target disk of a standby computer via a network.

It is possible to apply, to the above remote disk mirroring technique, the distributed mirrored disk system technique disclosed in the patent document. However, in the technique of the patent document, data on a disk of each computer included in a redundant system is efficiently duplicated when a failure occurs in one of the computers and the one computer is recovered from the failure. In other words, the technique of the patent document does not assume the case where a failure occurs in a disk and the disk is replaced. When a failed disk is replaced with a new disk, copy processing between disks similar to initialization is required, i.e., all data of a normal disk in a system must be copied to the new disk. Furthermore, in the technique of the patent document, even if a block to which data is written becomes unnecessary later, when the corresponding flag indicates inconsistency, the data of the block must be copied. This being so, the technique of the patent document is not suitable for initialization for remote disk mirroring in a redundant system utilizing the fail-over technique.

### BRIEF SUMMARY OF THE INVENTION

In accordance with an embodiment of the invention, there is provided a redundant system. The redundant system comprises two computers and a network connecting the computers to each other. Two computers include respective disks that include respective data areas. One of the two computers serves as a running computer, and the other computer serves as a standby computer. Each of the two computers further includes a remote-disk-mirroring driver configured to manage data input/output of a corresponding one of the disks, a file system configured to manage data on the disk of the each computer, and a copy driver. The file system divides the data area of the disk of the each computer into a plurality of blocks of a predetermined size, and performs management, using block management information, as to whether each of the plurality of blocks is a valid block which stores valid data. When the running computer operates, the remote-disk-mirroring driver of the running computer duplicates a request to write data to the disk of the running computer, causes the running computer to write the data to the disk of the running computer, and causes the standby computer to write the data to the disk of the standby computer via the network. Further, the copy driver of the running computer performs, during initialization for remote disk mirroring, a valid-block copy process for copying, from the disk of the running computer to the disk of the standby computer, only data of valid blocks included in the plurality of blocks, using the block management information.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of a redundant system, according to an embodiment, which utilizes remote disk mirroring;

FIG. 2 is a view illustrating a data structure example in the bit-map table 310-1 appearing in FIG. 1;

FIG. 3 is a view illustrating a state example of data on a mirroring target disk 30-1, which corresponds to the contents of the bit-map table 310-1 of FIG. 2;

FIG. 4 is a flowchart illustrating the procedure of initialization for remote disk mirroring employed in the embodiment; and

FIG. 5 is a view useful in explaining copying, to a mirroring target disk 30-2, data from the mirroring target disk 30-1 corresponding to the examples of FIGS. 2 and 3.

### DETAILED DESCRIPTION OF THE INVENTION

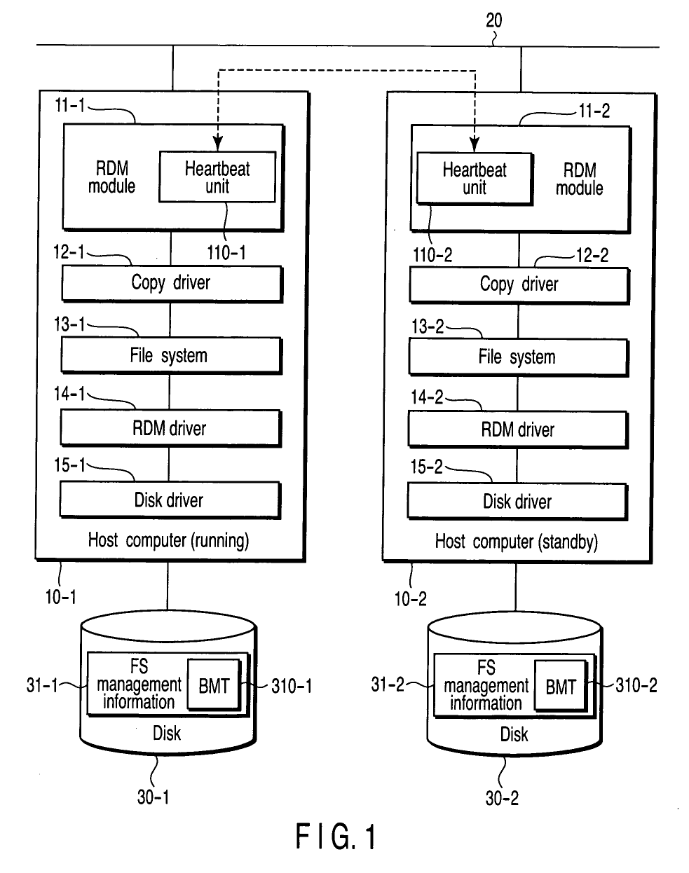

An embodiment of the invention will be described in detail with reference to the accompanying drawings. FIG. 1 is a block diagram illustrating a redundant system, according to the embodiment, to which remote disk mirroring is applied. As shown, the redundant system comprises two host computers 10-1 and 10-2. The host computers 10-1 and 10-2 are configured to be able to communicate with each other via a network 20. The redundant system formed of the host computers 10-1 and 10-2 can be accessed by client terminals (not shown) via the network 20. One of the host computers 10-1 and 10-2 serves as a running computer for providing services requested by client terminals. The other host computer serves as a standby computer for relaying services from the running computer when a failure has occurred in the latter. Assume here that the host computer 10-1 is the running computer, and the host computer 10-2 is the standby computer.

The host computers 10-1 and 10-2 are connected to disks (disk devices) as targets of redundancy, i.e., mirroring target disks (disk devices) 30-1 and 30-2. Each of the mirroring target disks 30-1 and 30-2 may be a logical disk formed of a plurality of physical disks. When data is written to the mirroring target disk 30-1 for the running computer 10-1, write data is copied to the mirroring target disk 30-2 for the standby computer 10-2, so that both the disks 30-1 and 30-2 have the same contents.

The host computers 10-1 and 10-2 comprise remote-disk-mirroring modules (hereinafter referred to as “the RDM modules”) 11-1 and 11-2, copy drivers 12-1 and 12-2, file systems 13-1 and 13-2, remote-disk-mirroring drivers (hereinafter referred to as “the RDM drivers”) 14-1 and 14-2, and disk drivers 15-1 and 15-2, respectively. When the RDM modules 11-1 and 11-2 can communicate with each other via the network 20, initialization, which includes negotiation as to which should serve as a running module, and initialization of remote disk mirroring, is performed.

In this embodiment, the host computers 10-1 and 10-2 read and execute particular application programs (cluster programs) installed therein, thereby realizing the RDM modules 11-1 and 11-2, respectively. These programs can be prestored in a computer readable recording medium and distributed in this state. Alternatively, they can be downloaded (distributed) via the network 20.

The RDM modules 11-1 and 11-2 include heartbeat units 110-1 and 110-2, respectively. The heartbeat unit 110-1 and 110-2 periodically communicate with each other via the network 20 to mutually confirm their operational states. This communication is called “heartbeat”. Failures/halts of the computers are detected by the timeout of a heartbeat signal. Namely, if no heartbeat signal is output for a predetermined period, it is considered that the computer is out of order. The heartbeat units 110-1 and 110-2 may be provided independently of the RDM modules 11-1 and 11-2.

During initialization of the mirroring target disks 30-1 and 30-2, the copy drivers 12-1 and 12-2 discriminate to-be-copied areas from not to-be-copied areas, and execute copy processing therein. For this discrimination, bit-map tables (BMT) 31-1 and 31-2, described later, are used. The file systems 13-1 and 13-2 manage data on the mirroring target disks 30-1 and 30-2, respectively. In the embodiment, the file systems 13-1 and 13-2 manage the data areas of the disks 30-1 and 30-2 in units of blocks having a predetermined size. For managing each block of the data areas of the disks 30-1 and 30-2, bit-map information as block management information, such as bit-map tables (BMT) 310-1 and 310-2, is used. The bit-map tables 310-1 and 310-2 are valid block information to indicate whether valid data is stored in each block of the data areas of the disks 30-1 and 30-2. The bit-map tables 310-1 and 310-2 are part of file system (FS) management information items 31-1 and 31-2, respectively. The file system (FS) management information items 31-1 and 31-2 are used for file management by the file systems 13-1 and 13-2, respectively. The file system management information items 31-1 and 31-2 are stored in particular areas allocated as management areas on the disks 30-1 and 30-2.

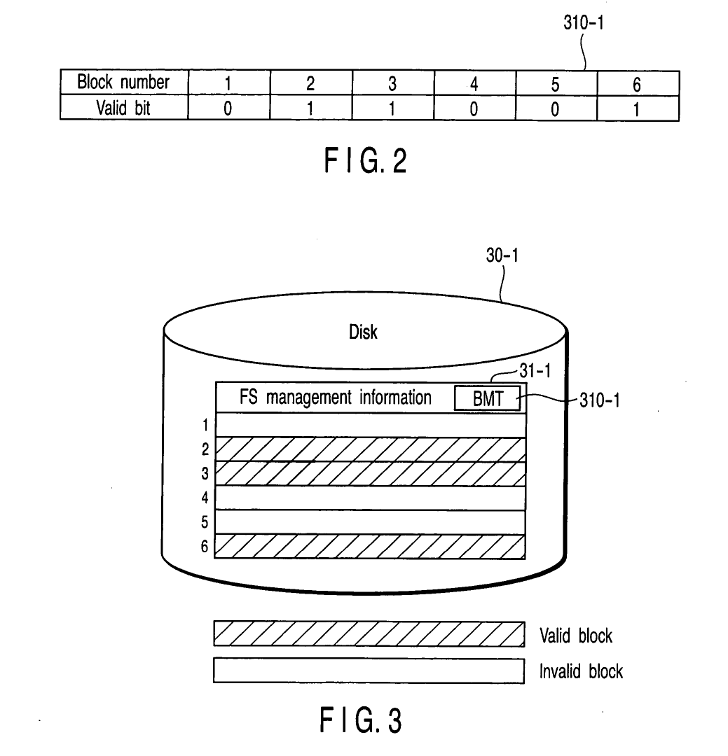

FIG. 2 shows a data structure example employed in the bit-map table 310-1. The bit-map table 310-1 is formed of a row of valid bits corresponding to the block number of each block of the disk 30-1. If the valid bit has a value of “1”, it indicates that the corresponding block is a used block, i.e., a valid block. On the other hand, if the valid bit has a value of “0”, it indicates that the corresponding block is an unused block, i.e., an invalid block. The invalid block (unused block) stores a value that is meaningless as data. The other bit-map table 310-2 has the same data structure as the bit-map table 310-1.

The bit-map table 310-1 shown in FIG. 2 indicates that the blocks with block numbers 2, 3 and 6 are used blocks, i.e., valid blocks, and the blocks with block numbers 1, 4 and 5 are unused blocks, i.e., invalid blocks. FIG. 3 shows the state of data on the disk 30-1, which corresponds to the contents of the bit-map table 310-1 of FIG. 2.

Referring again to FIG. 1, the RDM drivers 14-1 and 14-2 manage disk input/output (I/O) when the system is operated for remote disk mirroring, so that the contents of the disks 30-1 and 30-2 coincide with each other. The RDM driver 14-1 of the host computer 10-1 as the running computer duplicates a request for writing data to a mirroring target disk. As a result, the RDM driver 14-1 not only writes data to a block of the mirroring target disk 30-1 of the host computer 10-1, but also causes the host computer 10-2 as the standby computer to write the same data to the corresponding block of the mirroring target disk 30-2. On the other hand, the RDM driver 14-2 of the standby host computer 10-2 prevents data from being written to the disk 30-2 independently of the running host computer 10-1. The disk drivers 15-1 and 15-2 perform disk data input/output on the disks 30-1 and 30-2 under the control of the RDM drivers 14-1 and 14-2.

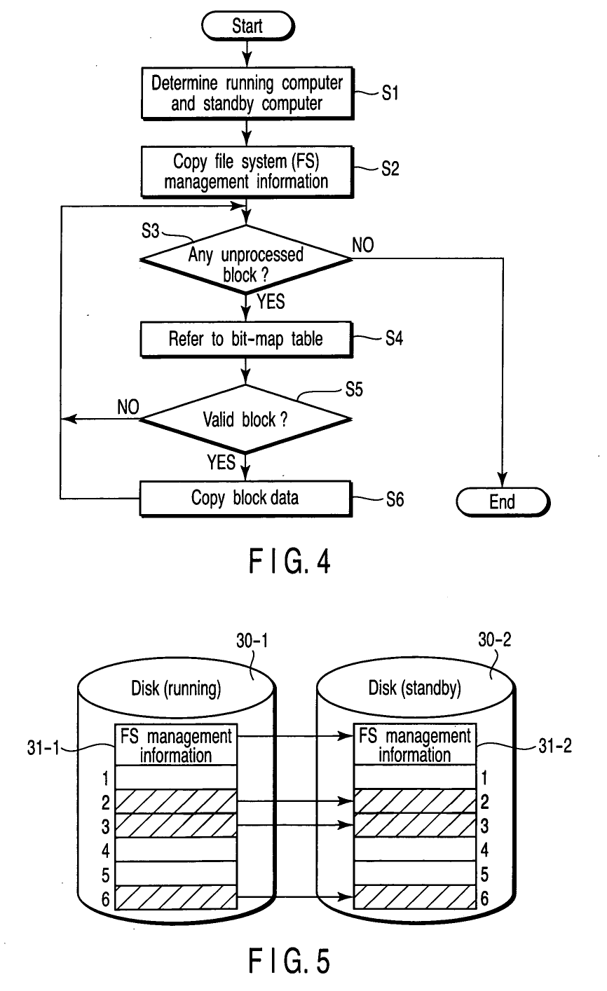

Referring to the flowchart of FIG. 4, a description will be given of initialization for remote disk mirroring in the redundant system of FIG. 1. The RDM modules 11-1 and 11-2 in the host computers 10-1 and 10-2 communicate with each other via the network 20. Assume here that the host computer 10-2 has failed and then recovered from the failure. Alternatively, assume that the mirroring target disk 30-2 of the host computer 19-2 has failed and has been exchanged for a new disk 30-2. In this case, when the RDM modules 11-1 and 11-2 have come to be mutually accessible, they try to cause the host computers 10-1 and 10-2 to start to operate as a redundant system. The host computers 10-1 and 10-2 perform initialization for remote disk mirroring by executing the procedure shown in FIG. 4.

Firstly, the RDM modules 11-1 and 11-2 of the host computers 10-1 and 10-2 communicate with each other, thereby performing a determination (negotiation) for causing one of the host computers to serve as a running computer, and the other computer to serve as a standby computer (step S1). It is well known that this determination is generally performed using management information for remote disk mirroring, such as generation management information, stored on the mirroring target disks 30-1 and 30-2. Therefore, no description will be given of the algorithm for the determination.

Assume that it is determined at step S1 that the host computer 10-1 serves as a running computer, and the host computer 10-2 serves as a standby computer. At this time, the RDM module 11-1 of the host computer 10-1 communicates with the RDM module 11-2 of the host computer 10-2 via the network 20. The RDM module 11-1 causes the host computer 10-2 to copy the file system (FS) management information 31-1, stored on the management area of the disk 30-1 of the running computer 10-1, to an area of the disk 30-2 of the standby computer 10-2 that has the same address as the management area, i.e., the management area of the disk 30-2 (step S2). The copied information is regarded as the file system management information 31-2. As a result, the bit-map table (BMT) 310-1 included in the file system management information 31-1 is copied as the bit-map table (BMT) 310-2 to the disk 30-2.

At this time, the copy driver 12-1 of the running computer 10-1 is activated. The copy driver 12-1 performs the following copy process on the areas (data areas) of the disks 30-1 and 30-2, other than the management areas, in units of blocks (data blocks) managed by the file system 13-1 using the bit-map table 310-1 (bit-map information). Firstly, the copy driver 12-1 refers to valid bits in the bit-map table 310-1 that correspond to each block (steps S3 and S4), thereby detecting each used block (i.e., valid block) on the disk 30-1 managed as a block storing valid data (step S5). After that, the copy driver 12-1 copies the data of each detected valid block to blocks of the disk 30-2 of the standby computer 10-2 that have the same addresses as each detected valid block (step S6). In contrast, concerning each unused block managed as an invalid block by the bit-map table 310-1 (step S5), the copy driver 12-1 does not perform copy from the disk 30-1 to the disk 30-2, and regards each unused block as a copy-finished one. The copy driver 12-1 performs the above operations on all blocks managed by the bit-map table 310-1 (step S3).

If, as a result of the above initialization, the bit-map table 310-1 assumes the state shown in FIG. 2 and the disk 30-1 has the contents as shown in FIG. 3, data copy as indicated by the arrows in FIG. 5 is performed from the disk 30-1 to the disk 30-2. Namely, the file system management information 31-1 and the data of only the blocks with block numbers 2, 3 and 6 are copied.

As described above, in initialization for remote disk mirroring performed in the embodiment, the file system management information and the data of only valid blocks are copied from the disk 30-1 of the running computer 10-1 to the disk 30-2 of the standby computer 10-2. As a result, the total amount of copy performed during initialization for remote disk mirroring can be suppressed, thereby minimizing the time required for the initialization. Moreover, since the blocks not copied are invalid blocks, no problems will occur.

When the initialization process is performed on all blocks in accordance with the flowchart of FIG. 4 (step S3), the process of making the data of the disk 30-2 coincide with that of the disk 30-1 is completed. When the coincidence process is completed, the redundant system of FIG. 2 starts to perform common remote disk mirroring. Namely, the RDM driver 14-1 of the running computer 10-1 duplicates a request for writing data to a block of the disk 30-1 to cause the standby computer 10-2 to copy the same data to the corresponding block of the disk 30-2 of the standby computer 10-2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A redundant system comprising:
two computers including respective disks that include respective data areas, one of the two computers serving as a running computer, and the other computer serving as a standby computer, each of the two computers further including a remote-disk-mirroring driver configured to manage data input/output of a corresponding one of the disks, a file system configured to manage data on the disk of said each computer, and a copy driver, the file system dividing the data area of the disk of said each computer into a plurality of blocks of a predetermined size, and performing management, using block management information, as to whether each of the plurality of blocks is a valid block which stores valid data; and
a network connecting the two computers to each other,
wherein when the running computer operates,
the remote-disk-mirroring driver of the running computer duplicates a request to write data to the disk of the running computer, causes the running computer to write the data to the disk of the running computer, and causes the standby computer to write the data to the disk of the standby computer via the network, and
the copy driver of the running computer performs, during initialization for remote disk mirroring, a valid-block copy process for copying, from the disk of the running computer to the disk of the standby computer, only data of valid blocks included in the plurality of blocks, using the block management information.

2. The redundant system according to claim 1, wherein:
the disk of said each computer includes a management area for storing file system management information used to manage data on the disk of said each computer, the file system management information including the block management information;
the file system of said each computer manages data on the disk of said each computer, using the file system management information which includes the block management information and is stored in the management area of the disk of said each computer;
the copy driver of the running computer executes, during the initialization for remote disk mirroring and before the valid-block copy process, a process of copying the file system management information, stored in the management area of the disk of the running computer, to the disk of the standby computer.

3. The redundant system according to claim 2, wherein the block management information includes valid block information indicating whether each of the plurality of blocks of the data area of the disk of said each computer is a valid block included in the valid blocks.

4. The redundant system according to claim 2, wherein when the standby computer operates, the remote-disk-mirroring driver of the standby computer inhibits an operation for writing data to the disk of the standby computer, independently of the running computer.

5. A computer for use in a redundant system, the computer being connected via a network to another computer for use in the redundant system, the computer and said another computer including respective disks to which same data is written, one of the computer and said another computer serving as a running computer, and the other of the computer and said another computer serving as a standby computer, the computer comprising:
a remote-disk-mirroring driver configured to manage data input/output of the disk of the computer, the remote-disk-mirroring driver duplicating a request to write data to the disk of the computer, causing the computer to write the data to the disk of the computer, and causing said another computer to write the data to the disk of said another computer via the network, when the computer and said another computer serve as the running computer and the standby computer, respectively;
a file system configured to manage data on the disk of the computer, the file system dividing the data area of the disk of the computer into a plurality of blocks of a predetermined size, and performing management, using block management information, as to whether each of the plurality of blocks is a valid block which stores valid data; and
a copy driver configured to perform, during initialization for remote disk mirroring, a valid-block copy process for copying, from the disk of the computer to the disk of said another computer, only data of valid blocks included in the plurality of blocks, using the block management information, when the computer and said another computer serve as the running computer and the standby computer, respectively.

6. The computer according to claim 5, wherein:
the disk of the computer includes a management area for storing file system management information used to manage data on the disk of the computer, the file system management information including the block management information;
the file system of the computer manages data on the disk of the computer, using the file system management information which includes the block management information and is stored in the management area of the disk of the computer;
the copy driver of the computer executes, during the initialization for remote disk mirroring and before the valid-block copy process, a process of copying the file system management information, stored in the management area of the disk of the computer, to the disk of said another computer, when the computer serves as the running computer.

7. The computer according to claim 6, wherein the block management information includes valid block information indicating whether each of the plurality of blocks of the data area of the disk of the computer is included in the valid blocks.

8. The computer according to claim 6, wherein when the computer serves as the standby computer, the remote-disk-mirroring driver of the computer inhibits an operation for writing data to the disk of the computer, independently of said another computer.

9. An initialization method for remote disk mirroring for use in a redundant system formed of two computers connected to each other via a network, the two computers including respective disks that include respective data areas, one of the two computers serving as a running computer, and the other computer serving as a standby computer, data recorded on each of the disks of the running computer and the standby computer being duplicated by duplicating a request to write the data to the disk of the running computer, and causing the running computer to write the data to the disk of the running computer, and causing the standby computer to write the data to the disk of the standby computer via the network, the initialization method comprising:
deciding which one of the two computers serves as the running computer by mutual communication between the two computers;
determining whether each block of a data area of the disk of the running computer is a valid block, when it is determined which one of the two computers serves as the running computer, the data area being managed by a file system in units of blocks; and
copying, from the disk of the running computer to the disk of the standby computer, only data of blocks determined to be valid blocks.

10. The initialization method according to claim 9, wherein:
the disk of each of the running computer and the standby computer includes a management area storing file system management information including block management information used to perform management as to whether each of the plurality of blocks is the valid block; and
the determining is performed, based on the block management information included in the file system management information stored in the management area of the disk of the running computer.

11. The initialization method according to claim 10, further comprising copying, before the copying only the data of the blocks determined to be valid blocks, the file system management information, stored in the management area of the disk of the running computer, to the management area of the disk of standby computer.
